(19) United States
(12) Patent Application Publication
(10) Pub. No.: US 2021/0377400 A1
(43) Pub. Date: Dec. 2, 2021

(54) IMAGE READING DEVICE AND IMAGE FORMING APPARATUS

(71) Applicant: RICOH COMPANY, LTD., TOKYO (JP)

(72) Inventor: Masahiro ISHIDA, Kanagawa (JP)

(73) Assignee: RICOH COMPANY, LTD., TOKYO (JP)

(21) Appl. No.: 17/323,111

(22) Filed: May 18, 2021

(30) Foreign Application Priority Data
Jun. 1, 2020 (JP) 2020-095257

(51) Int. Cl. H04N 1/00; H04N 1/32

(52) U.S. Cl. CPC H04N 1/00315; H04N 1/32138; H04N 1/0057; H04N 1/00342

(57) ABSTRACT

An image reading device includes a processing unit configured to perform short-range radio communication to perform at least one of data reading operation from an information storage unit mounted on an object to be scanned and data writing operation to the information storage unit, a first antenna unit configured to perform the short-range radio communication with the information storage unit mounted on the object to be scanned using a first communication mode, and a second antenna unit configured to perform the short-range radio communication with the information storage unit mounted on the object to be scanned using a second communication mode. In the image reading device, the processing unit performs the short-range radio communication to perform at least one of the data reading operation from the information storage unit and the data writing operation to the information storage unit, using the first communication mode or the second communication mode.

### CROSS-REFERENCE TO RELATED APPLICATION

This patent application is based on and claims priority pursuant to 35 U.S.C. § 119(a) to Japanese Unexamined Patent Application No. 2020-095257, filed on Jun. 1, 2020, in the Japan Patent Office, the entire disclosure of which is hereby incorporated by reference herein.

### BACKGROUND

### Technical Field

Embodiments of the present disclosure relate to an image reading device and an image forming apparatus.

### Background Art

In the related art, image reading devices that includes a pressing member, a moving scanner, and a processing unit are known in the art. The pressing member holds an object to be scanned placed on a mounting table, and the moving scanner scans the image on the object to be scanned while moving along the mounting table. The processing unit performs short-range radio communication to perform at least one of the data reading operation from an information storage unit provided for the object to be scanned and the data writing operation to the information storage unit.

For example, copiers are known in the art in which an antenna that serves as a reader and writer and performs data writing and data reading from a thin tag such as the information storage unit attached to the document such as the object to be scanned placed on a copying plane such as the mounting table is embedded in a cover such as the pressing member that holds the document on the copying plane.

### SUMMARY

Embodiments of the present disclosure described herein provide an image reading device including a processing unit configured to perform short-range radio communication to perform at least one of data reading operation from an information storage unit mounted on an object to be scanned and data writing operation to the information storage unit, a first antenna unit configured to perform the short-range radio communication with the information storage unit mounted on the object to be scanned using a first communication mode, and a second antenna unit configured to perform the short-range radio communication with the information storage unit mounted on the object to be scanned using a second communication mode. In the image reading device, the processing unit performs the short-range radio communication to perform at least one of the data reading operation from the information storage unit and the data writing operation to the information storage unit, using the first communication mode or the second communication mode.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a schematic diagram illustrating an image forming apparatus provided with an image reading unit shaped like a flat plate, where the cover of the image reading unit is open, according to a first embodiment of the present disclosure.

FIG. 2 is another schematic diagram illustrating the image forming apparatus of FIG. 1, where the cover of the image reading unit is closed.

FIG. 3 is a schematic diagram illustrating a configuration of a pressure plate for which no first radiofrequency identification (RFID) reader and writer is provided, according to the related art.

FIG. 4 is a schematic diagram illustrating a configuration of a pressure plate for which a first RFID reader and writer is provided, according to the first embodiment of the present disclosure.

FIG. 5 is a schematic diagram illustrating an alternative configuration of a pressure plate for which a first RFID reader and writer is provided, according to the first embodiment of the present disclosure.

FIG. 6 is a top view of an image reading unit in which a document is placed on a contact glass, according to a first embodiment of the present disclosure.

FIG. 7 is a plan view of the inside of a casing that accommodates a carriage when viewed from above, according to a first embodiment of the present disclosure.

FIG. 8 is a schematic diagram illustrating an image forming apparatus provided with an image reading unit of sheet through type, according to a second embodiment of the present disclosure.

FIG. 9 is a schematic diagram illustrating a configuration of a pressure plate for which a first RFID reader and writer is provided, according to a second embodiment of the present disclosure.

FIG. 10 is a block diagram of a main control system of an image forming apparatus including a controller, according to an embodiment of the present disclosure.

FIG. 11 is a flowchart of the operation performed by an image reading unit according to the first embodiment of the present disclosure.

FIG. 12 is a flowchart of the operation performed by an image reading unit according to the second embodiment of the present disclosure.

FIG. 13 is a flowchart of the operation of an image forming device according to an embodiment of the present disclosure.

FIG. 14 is a flowchart of the copying operation using an image reading unit according to the first embodiment of the present disclosure.

FIG. 15 is a flowchart of the copying operation using an image reading unit according to the second embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

An image forming apparatus that includes an image reading device according to an embodiment of the present disclosure is described below with reference to the drawings.

The image forming apparatus according to the present embodiment is provided with an electrophotographic image forming unit. However, no limitation is indicated thereby, and the image forming apparatus according to the present embodiment may be provided with image forming unit that adopts different image forming methods such as an inkjet printing system. The image forming apparatus according to the present embodiment is a tandem color image forming apparatus that adopts an intermediate transfer system in which the image forming unit is provided with four photoconductors. However, no limitation is indicated thereby, and the image forming apparatus according to the present embodiment may be a monochrome image forming apparatus or a color image forming apparatus a color image forming apparatus that adopts different methods or systems.

### First Embodiment

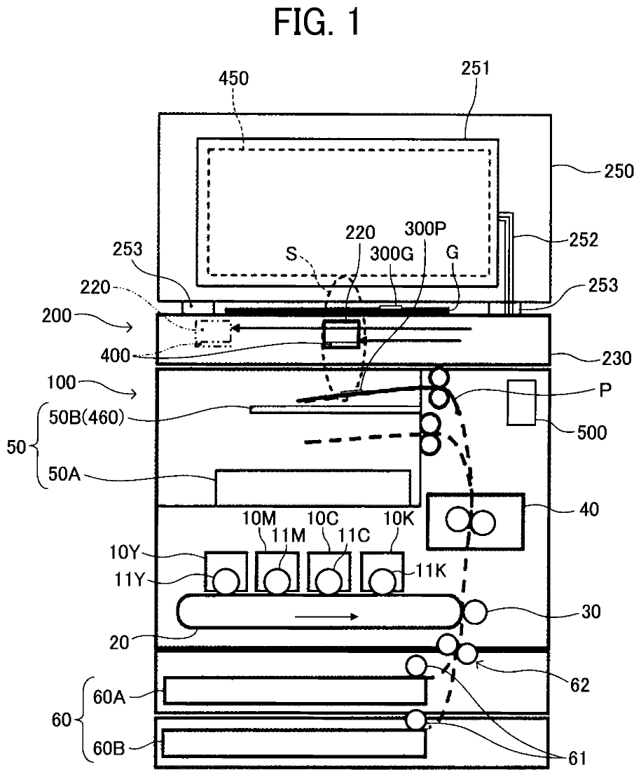

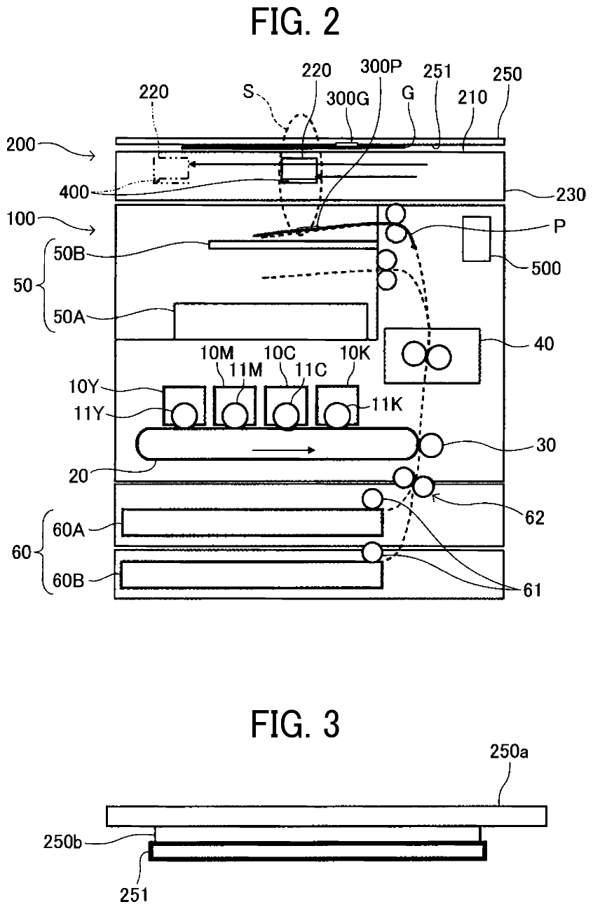

FIG. 1 and FIG. 2 are schematic diagrams each illustrating an image forming apparatus in which the image reading unit is shaped like a flatbed, according to a first embodiment of the present disclosure.

The image forming apparatus 1 according to the present embodiment includes, for example, an image forming device 100 that forms an image on a sheet of paper P that serves as a printing object and an image reading unit 200 that reads an image formed on a document G that serves as an object to be scanned. In the image forming apparatus 1 according to the present embodiment, the image reading unit 200 and the image forming device 100 are formed as a single integrated unit, and the image reading unit 200 is arranged above the image forming device 100. However, no limitation is indicated thereby, and the image reading unit 200 and the image forming unit device may be arranged in a separate manner. In such a configuration, the image reading unit 200 and the image forming device 100 are connected to each other and can communicate with each other.

Firstly, the image forming device 100 is described below.

The image forming device 100 is a tandem image forming apparatus in which a plurality of image forming units 10Y, 10M, 10C, and 10K that correspond to yellow (Y), magenta (M), cyan (C), and black (K) colors, respectively, are arranged along the rotation direction of an intermediate transfer belt 20 that serves as an intermediate transferor. The image forming units 10Y, 10M, 10C, and 10K are provided with a plurality of photoconductors 11Y, 11M, 11C, and 11K that serve as latent-image bearers, respectively. Each one of the multiple image forming units 10Y, 10M, 10C, and 10K is provided with a charging device, an optical writing device, a developing device, a primary transfer device, and a cleaner around the multiple photoconductors 11Y, 11M, 11C, and 11K. The charging device serves as a charger and evenly charges the surface of corresponding one of the photoconductors 11Y, 11M, 11C, and 11K at a predetermined level of electrical potential, and the optical writing device serves as an electrostatic latent image forming unit and expose the surface of corresponding one of the photoconductors 11Y, 11M, 11C, and 11K and write an electrostatic latent image on the surface of the corresponding one of the photoconductors 11Y, 11M, 11C, and 11K whose surfaces have been evenly charged by the charging devices according to the image data. The developing device forms a toner image through the developing procedure in which toner of corresponding one of the yellow (Y), magenta (M), cyan (C), and black (K) colors is made adhered to the electrostatic latent image formed on the corresponding one of the photoconductors, and the primary transfer device serves as a primary transfer unit and transfers the toner image formed on each one of the photoconductors onto the intermediate transfer belt 20. The cleaner removes and cleans the transfer residual toner formed on each one of the photoconductors.

The multicolor toner images that are formed on of the respective photoconductors 11Y, 11M, 11C, and 11K are primarily transferred onto the intermediate transfer belt 20 by the primary transfer device so as to be superimposed on top of one another. As a result, a color toner image is formed on the intermediate transfer belt 20. As the intermediate transfer belt 20 rotates, the color toner image that is formed on the intermediate transfer belt 20 is conveyed to the facing space where the intermediate transfer belt 20 and the secondary transfer device 30 face each other. The above facing space may be referred to as a secondary transfer area in the following description.

Moreover, in the configuration according to the first embodiment of the present disclosure, a sheet tray 60 that stores the sheet of paper P is provided under the image forming device 100. The sheet tray 60 according to the first embodiment of the present disclosure includes a pair of sheet feeding trays including an upper sheet feeding tray 60A and a lower sheet feeding tray 60B. The sheet tray 60 according to the present embodiment causes a pickup roller 61 to feed the sheet of paper P on a one-by-one basis from one of the upper sheet feeding tray 60A and the lower sheet feeding tray 60B, which is selected based on the instructions sent from the controller 500 of the image forming device 100. Accordingly, the sheet of paper P is conveyed to the secondary transfer area through a conveyance roller pair 62 along the conveyance path indicated by the broken lines in FIG. 1 and FIG. 2.

The color toner image that is formed on the intermediate transfer belt 20 is transferred onto the sheet P, which is conveyed through the conveyance roller pair 62 at a prescribed timing, at the secondary transfer area by a secondary transfer device 30 in the secondary transfer process. The sheet of paper P on which a color toner image has been formed is then conveyed to a fixing device 40 that serves as a fixing unit, and heat and pressure are applied to the sheet of paper P to fix the color toner image on the sheet of paper P. The sheet of paper P on which the color toner has been fixed is conveyed along the conveyance path indicated by the broken lines in FIG. 1 and FIG. 2, and is sent to a sheet ejection unit 50 that serves as an ejection unit.

The sheet ejection unit 50 according to the first embodiment of the present disclosure is disposed on the upper side of the image forming device 100, and a pair of output trays 50A and 50B that receive the sheet of paper P on which an image has been formed are arranged in two layers including an upper layer and a lower layer. The sheet of paper P on which the color toner has been fixed is ejected to one of the output trays 50A and 50B, which is selected based on the instructions sent from the controller 500 of the image forming device 100, through the output roller pair 51, and is placed on the output trays 50A and 50B.

The image reading unit 200 according to the present embodiment is described below.

The image reading unit 200 according to the first embodiment of the present disclosure includes a cover 250 provided with a pressure plate 251 that serves as a pressing member that holds the document G placed on the surface of the contact glass 210 and a carriage 220 that serves as a moving scanner and scan the image on the document G while moving under the contact glass 210 along the surface of the contact glass 210 in a horizontal direction.

The image reading unit 200 according to the first embodiment of the present disclosure includes, for example, a light source that irradiates the document G on the contact glass 210 with light, a plurality of reflection mirrors that guide the light reflected from the document G to a prescribed direction, a condenser lens through which the light reflected from the document G converges, and a charge coupled device (CCD) sensor that converts the converged reflection light into an electrical signal and outputs the obtained electrical signal. Among these elements of the image reading unit 200 according to the first embodiment of the present disclosure, the carriage 220 is equipped with the light source and some of the multiple reflection mirrors.

The pressure plate 251 according to the first embodiment of the present disclosure includes the first RFID reader and writer 450 that is provided with a first antenna unit that performs short-range radio communication with the RFID tag 300G that serves as an information storage unit of the document G. When the document G is placed on the contact glass 210 and the image on the document G is to be scanned, the cover 250 that is opened as illustrated in FIG. 1 is closed using a pair of hinges 253, and the document G is held by the pressure plate 251 of the cover 250. As a result, the first RFID reader and writer 450 that is attached to the pressure plate 251 comes in close proximity to the document G, and can perform short-range radio communication with the RFID tag 300G on the document G to read the data stored in the RFID tag 300G For example, ID data such as unique numbers is recorded onto the RFID tag 300G in advance so as to be distinguished from other RFID tags. In such a configuration, the first RFID reader and writer 450 reads such ID data, and sends the read ID data to the controller 500 of the image forming apparatus 1.

Moreover, the first RFID reader and writer 450 according to the present embodiment can perform short-range radio communication with the RFID tag 300G on the document G to write data to the RFID tag 300G. For example, the identification data of the image forming apparatus 1 according to the present embodiment that has scanned the image on the document G using the image reading unit 200, the date and time information of scanning, and the user data of the scanned image are written to the RFID tag 300G on the document G. As a result, the scanning history of the image on the document G is recorded on the RFID tag 300G on the document G.

The carriage 220 according to the first embodiment is equipped with a second RFID reader and writer 400 provided with a second antenna unit that performs short-range radio communication with the RFID tag 300G of the document G. Due to such a configuration, the second RFID reader and writer 400 according to the present embodiment can perform short-range radio communication with the RFID tag 300G on the document G to read the data stored in the RFID tag 300G while the carriage 220 is scanning the image on the document G. Moreover, the second RFID reader and writer 400 according to the present embodiment can perform short-range radio communication with the RFID tag 300G on the document G to write data to the RFID tag 300G while the carriage 220 is scanning the image on the document G.

The first RFID reader and writer 450 that is attached to the pressure plate 251 is configured so as to be able to communicate with the RFID tag 300G on the document G roughly all over the contact glass 210. The second RFID reader and writer 400 that is attached to the carriage 220 is configured so as to be able to communicate with the RFID tag 300G on the document G roughly all over the contact glass 210 as moving along the contact glass. Due to such a configuration, both the first RFID reader and writer 450 and the second RFID reader and writer 400 can read data from the RFID tag 300G or can write data to the RFID tag 300G regardless of the position of the RFID tag 300G provided for the document G.

In the present embodiment, the first RFID reader and writer 450 and the second RFID reader and writer 400 performs short-range radio communication with the RFID tag 300G on the document G using communication modes that are different from each other. More specifically, for example, the first RFID reader and writer 450 adopts a first communication mode that uses a high-frequency (HF) radio or radar signal whose band of frequencies is high to perform short-range radio communication, and the second RFID reader and writer 400 adopts a second communication mode that uses a ultrahigh frequency (UHF) radio or radar signal whose band of frequencies is ultrahigh to perform short-range radio communication. Due to such a configuration, when the document G that is placed on the contact glass 210 is held and the carriage 220 is moved to scan the image on the document G, the data reading operation from the RFID tag 300G on the document G and the data writing operation to the RFID tag 300G on the document G can be performed with the first communication mode that uses a HF radio or radar signal whose band of frequencies is high, and the data reading operation from the RFID tag 300G on the document G and the data writing operation to the RFID tag 300G on the document G can be performed with the second communication mode that uses a UHF radio or radar signal whose band of frequencies is ultrahigh.

In other words, according to the present embodiment, several kinds of documents including the document G having the RFID tag 300G compatible with the first communication mode that uses a HF radio or radar signal whose band of frequencies is high, the document G having the RFID tag 300G compatible with the second communication mode that uses a UHF radio or radar signal whose band of frequencies is ultrahigh, and the document G having both types of RFID tags 300G can be dealt with.

In the present embodiment, in particular, the first RFID reader and writer 450 that is attached to the pressure plate 251 adopts the first communication mode that uses a HF radio or radar signal whose band of frequencies is high, and the communication range of such a communication mode is short. However, when the document G is held by the pressure plate 251, the first RFID reader and writer 450 that is attached to the pressure plate 251 comes in close proximity to the document G. Due to such a configuration, the data reading operation from the RFID tag 300G on the document G and the data writing operation to the RFID tag 300G on the document G can appropriately be performed even with first communication mode with a short communication range that uses a HF radio or radar signal whose band of frequencies is high.

By contrast, in the present embodiment, the second RFID reader and writer 400 that is attached to the carriage 220 adopts the second communication mode that uses a UHF radio or radar signal whose band of frequencies is ultrahigh, and the communication range of the second communication mode is longer than the communication range of the first communication mode that uses a high-frequency (HF) radio or radar signal whose band of frequencies is high. Due to such a configuration, even if the distance between the carriage 220 and the document G is long to a certain extent, the data reading operation from the RFID tag 300G on the document G and the data writing operation to the RFID tag 300G on the document G can appropriately be performed.

If both the first RFID reader and writer 450 and the second RFID reader and writer 400 are disposed on either one of the pressure plate 251 and the carriage 220, the member on which both the first RFID reader and writer 450 and the second RFID reader and writer 400 are disposed tends to increase in size. In such cases, the image reading unit 200 increases in size, and thus the image forming apparatus 1 tends to increase in size.

In the present embodiment, as described as above, the first RFID reader and writer 450 and the second RFID reader and writer 400 are disposed on the pressure plate 251 and the carriage 220, respectively, in a distributed manner. Due to such a configuration, the upsizing of each one of the pressure plate 251 and the carriage 220 can be prevented, and the upsizing of the image reading unit 200 and the upsizing of the image forming apparatus 1 can be avoided.

The accessibility of the pressure plate 251 on which the first RFID reader and writer 450 is mounted is greater than the accessibility of the members arranged inside the image forming apparatus 1, and the maintenance of the pressure plate 251 on which the first RFID reader and writer 450 is easier than the maintenance of the members arranged inside the image forming apparatus 1. As it is easy to replace the pressure plate, it is also easy to replace a known pressure plate of the image forming apparatus 1 with the pressure plate 251 on which the first RFID reader and writer 450 according to the present embodiment is mounted to obtain the image forming apparatus 1 according to the present embodiment.

The accessibility of the carriage 220 that is provided with the second RFID reader and writer 400 is also high as it is relatively easy to remove the contact glass 210, and the maintenance of the carriage 220 that is provided with the second RFID reader and writer 400 is easy.

FIG. 3 is a schematic diagram illustrating a configuration of the pressure plate 251 for which the first RFID reader and writer 450 is not provided, according to the related art.

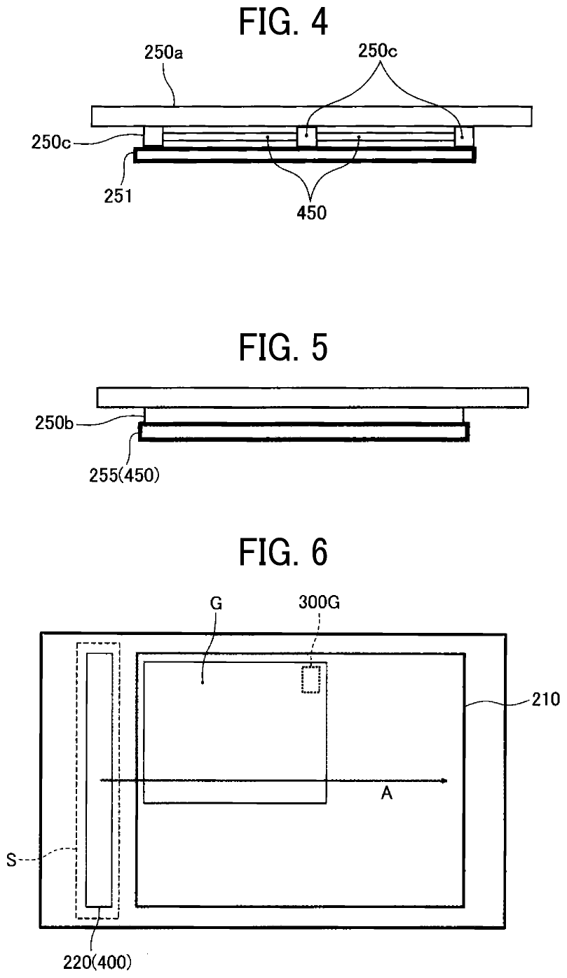

FIG. 4 is a schematic diagram illustrating a configuration of the pressure plate 251 for which the first RFID reader and writer 450 is provided, according to the first embodiment of the present disclosure.

FIG. 5 is a schematic diagram illustrating an alternative configuration of the pressure plate 251 for which the first RFID reader and writer 450 is provided, according to the first embodiment of the present disclosure.

As illustrated in FIG. 3, in the pressure plate 251 according to the related art, an elastic body 250b such as a sponge is disposed between the base 250a and the pressure plate 251, and the pressure plate 251 can shift due to the elastic deformation of the elastic body 250b. As known in the art, one of the surfaces of the pressure plate 251 is white because, for example, the background image of the document G needs to be plain and unpatterned when the image of the document G is to be scanned.

As illustrated in FIG. 4, in the pressure plate 251 according to the present embodiment, the first RFID reader and writer 450 is disposed in the space where an elastic body 250c such as a spring is disposed between the base 250a and the pressure plate 251, and the first RFID reader and writer 450 is supported by the elastic body 250c. In a similar manner to the related art, the pressure plate 251 according to the present embodiment is configured such that it can shift due to the elastic deformation of the elastic body 250c.

Alternatively, as illustrated in FIG. 5, a pressure plate 255 in which the pressure plate and the first RFID reader and writer 450 are formed as a single integrated unit may be used in place of the pressure plate 251 according to the present embodiment. In the alternative embodiment as illustrated in FIG. 5, the assembly can be done more efficiently as the number of components is reduced, and the first RFID reader and writer 450 can be disposed at a position closer to the document G. Accordingly, the precision of the data reading or the precision of the data writing can be improved.

In the first embodiment of the present disclosure, the carriage 220 on which the second RFID reader and writer 400 is mounted is accommodated inside the casing 230, and the carriage 220 moves back and forth inside the casing 230. In view of, for example, the rigidity or safety, it is desired that the casing 230 of the carriage 220 be made of metal such as a steel sheet and an aluminum plate. However, such a case 230 that is made of metal tends to block a radio or radar signal. In the present embodiment, it is necessary for the second RFID reader and writer 400 mounted on the carriage 220 to perform short-range radio communication with the RFID tag 300G on the document G that is placed above the second RFID reader and writer 400. Due to such a configuration, the casing 230 has an opening on the upper side at the position at which the second RFID reader and writer 400 mounted on the carriage 220 performs the short-range radio communication. In the first embodiment of the present disclosure, the second RFID reader and writer 400 that is mounted on the carriage 220 performs short-range radio communication with the RFID tag 300G on the document G while the carriage 220 is moving to scan the image on the document G. For this reason, the casing 230 is open approximately all over its top surface. The opening on the top surface of the casing 230 may be closed by a member that does not block the radio wave of the short-range radio communication. Preferably, a fire-resistant material is used as such a material that closes the opening on the top surface of the casing 230.

FIG. 6 is a top view of the image reading unit 200 in which the document G is placed on the contact glass 210, according to the present embodiment.

the effective range in which the communication is enabled and the second RFID reader and writer 400 that is attached to the carriage 220 can perform the data reading operation from the RFID tag 300G on the document G and the data writing operation to the RFID tag 300G on the document G is approximately equivalent to the range that is covered by broken lines and is indicated by a reference sign S in FIG. 6. The range in which the communication is enabled according to the first embodiment of the present disclosure is approximately equivalent to the readable range of the image that can be scanned by the image reading unit 200 in the up-and-down directions in FIG. 6 that are perpendicular to the right and left directions in FIG. 6 in which the carriage 220 moves. However, no limitation is indicated thereby, and the range in which the communication is enabled according to the first embodiment of the present disclosure may be narrower than or wider than the readable range of the image. Typically, the readable range of the image is configured to be equal to or slightly wider than the width of the document G of the maximum readable size.

When the image on the document G is to be scanned and obtained by the image reading unit 200, the carriage 220 is moved from the standby position indicated by a solid line in FIG. 6, which corresponds to the position at which the carriage 220 is indicated by a virtual line in FIG. 1, in the horizontal directions indicated by an arrow A in FIG. 6. Due to such a configuration, the image on the document G can be read as desired all across the document G that is placed on the contact glass 210. Moreover, as the second RFID reader and writer 400 moves back and forth as the carriage 220 moves during the image reading operation, data can be read from the RFID tag 300G on the document G and data can be written to the RFID tag 300G on the document G all across the document G that is placed on the contact glass 210. Due to such a configuration, regardless of the position of the RFID tag 300G provided for or pasted on the document G, data can be read from the RFID tag 300G on the document G and data can be written to the RFID tag 300G on the document G.

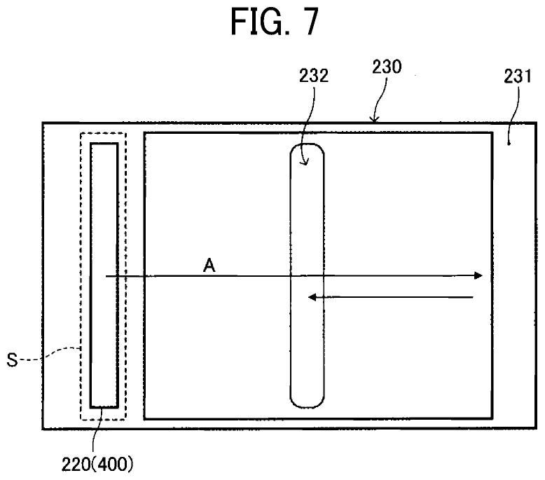

FIG. 7 is a plan view of the inside of the casing 230 that accommodates the carriage 220 when viewed from above, according to the present embodiment.

The second RFID reader and writer 400 provided for the carriage 220 according to the first embodiment of the present disclosure may also serve as an antenna unit that performs short-range radio communication with the RFID tag 300P that serves as an information storage unit of the sheet of paper P on which an image is formed by the image forming device 100. Due to such a configuration, the second RFID reader and writer 400 according to the present embodiment, and can perform short-range radio communication with the RFID tag 300P on the sheet of paper P on which an image is formed to read the data stored in the RFID tag 300P. For example, ID data such as unique numbers is recorded onto the RFID tag 300P in advance so as to be distinguished from other RFID tags. In such a configuration, the second RFID reader and writer 400 reads such ID data, and sends the read ID data to the controller 500 of the image forming apparatus 1.

Moreover, the second RFID reader and writer 400 according to the present embodiment can perform short-range radio communication with the RFID tag 300P on the sheet of paper P on which an image is formed to write data to the RFID tag 300P. For example, the identification data of the image forming apparatus 1 according to the present embodiment that has formed an image on the sheet of paper P, the date and time information of image formation, and the user data of the formed image are written to the RFID tag 300P on the sheet of paper P. As a result, the formation history of the image on the sheet of paper P is recorded on the RFID tag 300P on the sheet of paper P.

In the first embodiment of the present disclosure, the second RFID reader and writer 400 is provided for the carriage 220 of the image reading unit 200. Due to such a configuration, preferably, the data reading operation from the RFID tag 300P on the sheet of paper P and the data writing operation to the RFID tag 300P on the sheet of paper P are performed above the image forming device 100 close to the image reading unit 200. Due to such a configuration, the distance can be shortened that the carriage 220 is moved to the position at which the short-range radio communication is performed with the RFID tag 300P on the sheet of paper P. Moreover, for example, the length of time of the movement can be shortened, and the space for the path of the movement can be reduced.

In view of such circumstances, in the first embodiment of the present disclosure, when the sheet of paper P is ejected to the sheet ejection unit 50 that is disposed on the upper side of the image forming device 100, the controller 500 performs the data reading operation from the RFID tag 300P on the sheet of paper P and the data writing operation to the RFID tag 300P on the sheet of paper P. More specifically, data is read from the RFID tag 300P on the sheet of paper P that is ejected to the upper output tray 50B that is close to the second RFID reader and writer 400, and data is written to the RFID tag 300P on the sheet of paper P that is ejected to the upper output tray 50B that is close to the second RFID reader and writer 400, from among the pair of output trays 50A and SOB of the sheet ejection unit 50. Due to such a configuration, even if the connectable range of the second RFID reader and writer 400 is short, the data reading operation from the RFID tag 300P on the ejected sheet of paper P and the data writing operation to the RFID tag 300P on the ejected sheet of paper P can appropriately be performed.

The timing at which data is read from the RFID tag 300P on the sheet of paper P or data is written to the RFID tag 300P on the sheet of paper P is not limited to when the sheet of paper P is ejected to the sheet ejection unit SO. For example, data may be read from the RFID tag 300P on the sheet of paper P or data may be written to the RFID tag 300P on the sheet of paper P while the sheet of paper is being conveyed after the fixation is done inside the image forming device 100, or data may be read from the RFID tag 300P on the sheet of paper P or data may be written to the RFID tag 300P on the sheet of paper P while the sheet of paper is being conveyed after the secondarily-transferring process is done but before the fixation is done. Alternatively, data may be read from the RFID tag 300P on the sheet of paper P or data may be written to the RFID tag 300P on the sheet of paper P while the sheet of paper is being conveyed from the sheet tray 60 before the secondarily-transferring process starts. However, when the data reading operation from the RFID tag 300P on the sheet of paper P or the data writing operation to the RFID tag 300P on the sheet of paper P is performed while the sheet of paper P is being ejected to the sheet ejection unit 50 as in the first embodiment of the present disclosure, the data can be read from the RFID tag 300P on the sheet of paper P on which an image has been formed and the data writing operation to the RFID tag 300P on the sheet of paper P on which an image has been formed.

As described above, in the first embodiment of the present disclosure, the carriage 220 on which the second RFID reader and writer 400 is mounted is accommodated inside the casing 230. Due to such a configuration, when the data is to be read from the RFID tag 300G on the document G or when the data is to be written to the RFID tag 300G on the document G, the radio wave of the short-range radio communication does not reach the RFID tag 300P of the sheet of paper P on the image forming device 100 side, in particular, the sheet of paper P ejected to the sheet ejection unit 50. However, in the first embodiment of the present disclosure, there are some cases in which the second RFID reader and writer 400needs to be used for the data reading operation from the RFID tag 300P on the sheet of paper P and the data writing operation to the RFID tag 300P on the sheet of paper P that is ejected to an upper output tray 50B of the sheet ejection unit 50.

For this reason, as illustrated in FIG. 7, an opening 232 is formed on the bottom of the casing 230 at the position where the second RFID reader and writer 400 mounted on the carriage 220 performs the short-range radio communication with the RFID tag 300P on the sheet of paper P that is ejected to the upper output tray 50B of the sheet ejection unit 50. The opening 232 of the casing 230 may be filled and closed by a member that does not block the radio wave of the short-range radio communication. Preferably, a fire-resistant material is used as such a member that fills and closes the opening 232 on the top surface of the casing 230.

As described above, in the first embodiment of the present disclosure, each one of the data reading operation from the RFID tag 300G on the document G and the data writing operation to the RFID tag 300G on the document G, the data reading operation from the RFID tag 300P on the sheet of paper P on which an image to be formed, and the data writing operation to the RFID tag 300P on the sheet of paper P on which an image is to be formed is performed and implemented by the short-range radio communication with the same second RFID reader and writer 400. Due to such a configuration, for example, the number of components can be reduced, and the footprint can be reduced compared with a configuration or structure in which a plurality of RFID readers and writers are provided on an individual basis for each process.

In the first embodiment of the present disclosure, it is difficult to use the first RFID reader and writer 450 that is attached to the pressure plate 251 for the data reading operation from the RFID tag 300P on the sheet of paper P and the data writing operation to the RFID tag 300P on the sheet of paper P, in view of the communication range. For this reason, the data reading operation from the RFID tag 300P on the sheet of paper P and the data writing operation to the RFID tag 300P on the sheet of paper P can be performed with the second communication mode of the second RFID reader and writer 400 that uses a UHF radio or radar signal whose band of frequencies is ultrahigh, but cannot be performed with the first communication mode of the first RFID reader and writer 450 that uses a HF radio or radar signal whose band of frequencies is high.

As the data reading operation from the RFID tag 300P on the sheet of paper P and the data writing operation to the RFID tag 300P on the sheet of paper P can be done using the first communication mode that uses a HF radio or radar signal whose band of frequencies is high, a third RFID reader and writer 460 that performs short-range radio communication with the RFID tag 300P on the sheet of paper P using the first communication mode that uses a HF radio or radar signal whose band of frequencies is high may be disposed on, for example, the upper output tray 50B. Due to the provision of the third RFID reader and writer 460, several kinds of sheet of paper including the sheet of paper P having the RFID tag 300P compatible with the first communication mode that uses a HF radio or radar signal whose band of frequencies is high, the sheet of paper P having the RFID tag 300P compatible with the second communication mode that uses a UHF radio or radar signal whose band of frequencies is ultrahigh, and the sheet of paper P having both of the two types of RFID tags 300P can be dealt with.

### Second Embodiment

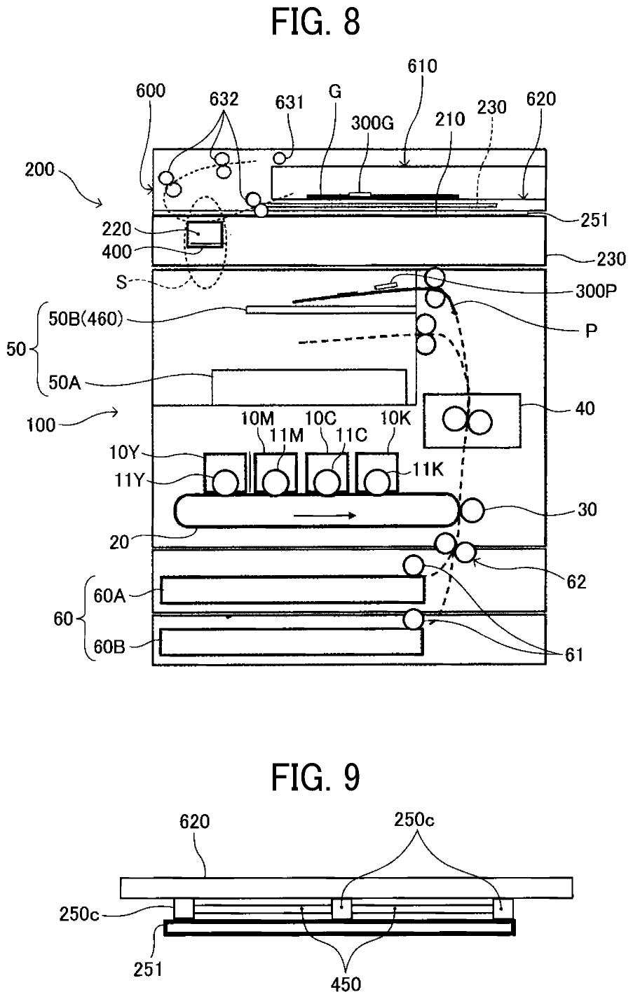

FIG. 8 is a schematic diagram illustrating the image forming apparatus in which the image reading unit is of sheet through type, according to a second embodiment of the present disclosure.

The configuration or structure of the image forming device 100 in the image forming apparatus 1 according to the second embodiment of the present disclosure is equivalent to the configuration or structure of the first embodiment of the present disclosure as described above. Accordingly, the description of the configuration or structure of the image forming device 100 according to the second embodiment of the present disclosure is omitted, and overlapping descriptions with the description of the first embodiment as described above is omitted where appropriate.

The image reading unit 200 according to the second embodiment of the present disclosure is provided with an automatic document feeder (ADF) 600 that serves as the conveyance unit. The ADF 600 conveys the document G that is set on a document table 610 on a one-piece-by-one-piece basis using a pickup roller 631. The document G that is conveyed by the pickup roller 631 is conveyed along the conveyance path indicated by the broken lines in FIG. 8 by a plurality of conveyance roller pairs 632, and is ejected onto a document ejection stage 620 that serves as a container.

In a similar manner to the configuration or structure of the first embodiment of the present disclosure as described above, the image reading unit 200 according to the second embodiment of the present disclosure is provided with the carriage 220, and can read the image on the document G placed on the contact glass 210. When the image on the conveyed document G conveyed by the ADF 600 is to be read in the second embodiment of the present disclosure, the carriage 220 stops at a standby position indicated by a solid line in FIG. 8. The carriage 220 is kept stationary, and the image on the document G is scanned and obtained while the document G conveyed by the ADF 600 is passing through the image reading area above the carriage 220.

The carriage 220 according to the second embodiment of the present disclosure is also provided with a second RFID reader and writer 400 that performs short-range radio communication with the RFID tag 300G of the document G. Due to such a configuration, while the document G is passing through the image reading area above the carriage 220 that is kept stationary at the standby position, the second RFID reader and writer 400 according to the present embodiment can perform short-range radio communication with the RFID tag 300G on the document G to read the data stored in the RFID tag 300G, and can perform short-range radio communication with the RFID tag 300G on the document G to write data to the RFID tag 300G.

As illustrated in FIG. 9, the pressure plate 251 according to the second embodiment of the present disclosure is provided with the first RFID reader and writer 450 that performs short-range radio communication with the RFID tag 300G of the document G. Due to such a configuration, when the document G is ejected to the document ejection stage 620 that exists above the pressure plate 251, the first RFID reader and writer 450 can perform short-range radio communication with the RFID tag 300G on the document G to read the data stored in the RFID tag 300G of the document G. Moreover, when the document G is ejected to the document ejection stage 620 that exists above the pressure plate 251, the first RFID reader and writer 450 can perform short-range radio communication with the RFID tag 300G on the document G to write data to the RFID tag 300G of the document G.

The second RFID reader and writer 400 provided for the carriage 220 according to the second embodiment of the present disclosure can perform short-range radio communication with the RFID tag 300P of the sheet of paper P on which an image is formed by the image forming device 100 to read the data stored in the RFID tag 300P. Moreover, the second RFID reader and writer 400 according to the present embodiment can perform short-range radio communication with the RFID tag 300P on the sheet of paper P on which an image is formed to write data to the RFID tag 300P.

In a similar manner to the configuration or structure of the first embodiment of the present disclosure as described above, the data reading operation from the RFID tag 300P on the sheet of paper P and the data writing operation to the RFID tag 300P on the sheet of paper P that is ejected to an upper output tray 50B of the sheet ejection unit 50 are also performed in the second embodiment of the present disclosure. In other words, when the data reading operation from the RFID tag 300P on the sheet of paper P and the data writing operation to the RFID tag 300P on the sheet of paper P are performed, the carriage 220 is moved to the position at which the carriage 220 is indicated by a virtual line in FIG. 8, and the short-range radio communication is performed with the RFID tag 300P on the sheet of paper P through the opening 232 that is arranged on the bottom of the casing 230. Such a position at which the carriage 220 is indicated by a virtual line may be referred to as the second communicating position.

As described above, also in the second embodiment of the present disclosure, each one of the data reading operation from the RFID tag 300G on the document G and the data writing operation to the RFID tag 300G on the document G and the data reading operation from the RFID tag 300P on the sheet of paper P on which an image to be formed and the data writing operation to the RFID tag 300P on the sheet of paper P on which an image is to be formed is performed and implemented by the short-range radio communication that is perfumed by the same second RFID reader and writer 400. Accordingly, effects similar to those achieved by the first embodiment of the present disclosure as described above can be achieved in the second embodiment of the present 1 5 disclosure.

As illustrated in FIG. 8, the conveyance path of the document G in the ADF 600 according to the second embodiment of the present disclosure turns. Due to such a configuration, the document G such as a plastic card and a cardboard cannot be conveyed through the ADF 600 according to the second embodiment of the present disclosure. In order to avoid such a situation, a straight conveyance path through which the document is conveyed without being bent may additionally be arranged inside the ADF 600.

The operation of the image forming apparatus according to the present embodiment is described below.

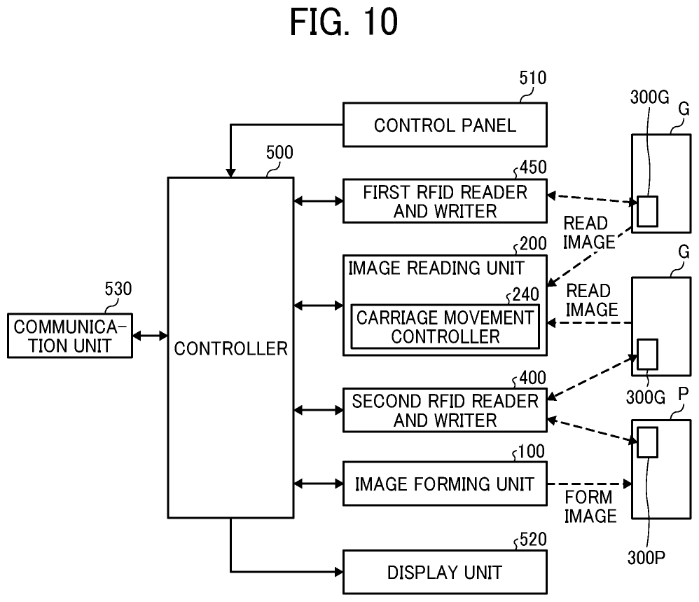

FIG. 10 is a block diagram of a main control system of the image forming apparatus 1 including the controller 500, according to the present embodiment.

The controller 500 according to the above embodiments of the present disclosure controls entire operation of the image forming apparatus 1. In order to achieve such functions, the elements of a computer such as a central processing unit (CPU), a random-access memory (RAM), and a read only memory (ROM) execute a computer program such as various kinds of control programs. As a result, various kinds of processes and various kinds of controls are executed.

The controller 500 according to the above embodiments of the present disclosure serves as a processing unit when it reads data from the RFID tag 300G on the document G or writes data to the RFID tag 300G on the document G. Moreover, the controller 500 controls the elements of the image reading unit 200 to perform the image-forming operation on the document G in accordance with the selection made on an control panel 510, and controls at least corresponding one of the first RFID reader and writer 450 and the second RFID reader and writer 400 to perform the data reading operation from the RFID tag 300G on the document G and the data writing operation to the RFID tag 300G on the document G. the notification of an error or a result of controlling operation is displayed on the display unit 520.

The RFID tag 300P is provided for the sheet of paper P on which the image forming device 100 forms an image, and the controller 500 according to the above embodiments of the present disclosure serves as a data communication processing unit when the controller 500 performs the data reading operation from the RFID tag 300P and the data writing operation to the RFID tag 300P. Moreover, the controller 500 controls the elements of the image forming device 100 to perform the image-forming operation on the sheet of paper P in accordance with the selection made on the control panel 510, and controls the second RFID reader and writer 400 to perform the data reading operation from the RFID tag 300P on the sheet of paper P and the data writing operation to the RFID tag 300P on the sheet of paper P. The notification of an error or a result of controlling operation is displayed on the display unit 520.

Moreover, when the data reading operation from the RFID tag 300G and the RFID tag 300P on the document G and the sheet of paper P or the data writing operation to the RFID tag 300G and the RFID tag 300P on the document G and the sheet of paper P is completed, the controller 500 according to the above embodiments of the present disclosure may control the communication unit 530 to send an electronic mail to a destination that is specified in advance to deliver, for example, the data read from the RFID tag 300G or the RFID tag 300P and the data written to the RFID tag 300G or the RFID tag 300P, the image data read from the document G, or the image data formed on the sheet of paper P. Alternatively, the controller 500 according to the above embodiments of the present disclosure may control the communication unit 530 to send, for example, the data read from the RFID tag 300G or the RFID tag 300P and the data written to the RFID tag 300G or the RFID tag 300P, the image data read from the document G, or the image data formed on the sheet of paper P to a prescribed server.

The operation of the image forming apparatus according to the present embodiment is described below.

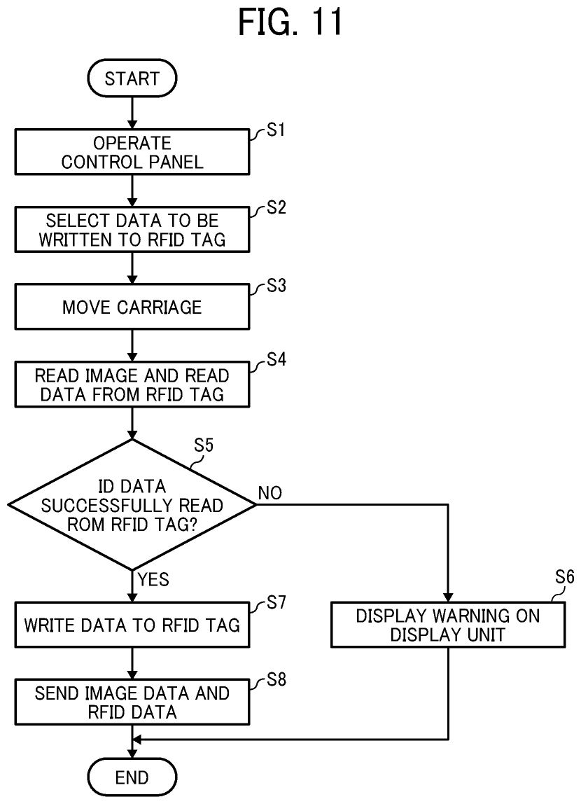

FIG. 11 is a flowchart of the operation using the image reading unit 200 shaped like a flat plate, according to the first embodiment of the present disclosure.

When the image on the document G provided with the RFID tag 300G is to be scanned and obtained, firstly, the document G is placed on the contact glass 210, and the cover 250 is closed. As a result, the document G is held by the pressure plate 251. Subsequently, in a step S1, a selection is made on the control panel 510 of the image forming apparatus 1 to set the conditions for image reading or scanning. When some data is to be written to the RFID tag 300G on the document G, in a step S2, a selection is made as to what data is to be written. The data to be written may be, for example, the date and time information, the user data, and the data of security level.

Once a result of the above selection is input to the control panel 510, in a step S3, the controller 500 moves the carriage 220, and performs image reading operation to read the image on the conveyed document G placed on the contact glass 210. In a step S4, the controller 500 performs the data reading operation from the RFID tag 300G on the document G using the second communication mode that uses a UHF radio or radar signal whose band of frequencies is ultrahigh while the carriage 220 is being moved, by means of the second RFID reader and writer 400 mounted on the carriage 220. In the step S4, the controller 500 also performs the data reading operation from the RFID tag 300G on the document G together with the above data reading operation or at a timing before or after the above data reading operation, using the first communication mode that uses a HF radio or radar signal whose band of frequencies is high, by means of the first RFID reader and writer 450 that is attached to the pressure plate 251. When the communication mode is specified and input in advance, the data reading operation is to be performed using only the specified communication mode, and the data reading operation is not necessarily performed using a communication mode that is not specified.

When the controller 500 has failed to read the data such as the ID data from the RFID tag 300G on the document G regardless of the first RFID reader and writer 450 and the second RFID reader and writer 400 that is used (“NO” in the step S5), in a step S6, the controller 500 causes the display unit 520 to display, for example, a warning message saying “FAILED TO ACQUIRE DATA FROM RFID”, and terminates the image reading operation.

On the other hand, when the controller 500 has successfully read the data such as the ID data from the RFID tag 300G on the document G using either one of the first RFID reader and writer 450 and the second RFID reader and writer 400 (“YES” in the step S5), in a step S7, the controller 500 then writes the data selected in the above processing step S2 to the RFID tag 300G on the document G, using one of the first RFID reader and writer 450 or the second RF1D reader and writer 400 that has successfully read the data in the previous steps. Once the data reading operation from the RFID tag 300G on the document G and the data writing operation to the RFID tag 300G on the document G is completed, in a step S8, the controller 500 uses the communication unit 530 to transmit the data read from the RFID tag 300G, the data written to the RFID tag 300G, and the image data read from the document G

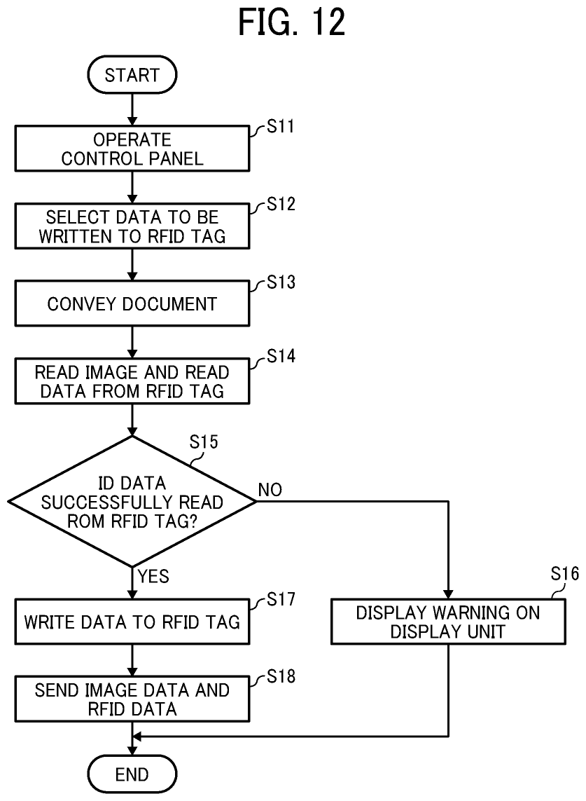

FIG. 12 is a flowchart of the operation using the image reading unit 200 of sheet through type, according to the second embodiment of the present disclosure.

First of all, the document G is set on the document table 610 as the ADF 600 is closed. Subsequently, in steps S11 and S12, a selection is made on the control panel 510 of the image forming apparatus 1 in a similar manner to the image reading unit 200 shaped like a flat plate. Then, in a step S13, the controller 500 causes the ADF 600 to convey the document G, and performs image reading operation to read the image on the conveyed document G. During the above image reading operation, in a step S14, the controller 500 performs the data reading operation from the RFID tag 300G on the document G using the second communication mode that uses a UHF radio or radar signal whose band of frequencies is ultrahigh, by means of the second RFID reader and writer 400 mounted on the carriage 220. In the step S14, while the conveyed document G is being ejected to the document ejection stage 620, the controller 500 also performs the data reading operation from the RFID tag 300G on the document G using the first communication mode that uses a HF radio or radar signal whose band of frequencies is high, by means of the first RFID reader and writer 450 that is attached to the pressure plate 251.

When the controller 500 has failed to read the data such as the ID data from the RFID tag 300G on the document G regardless of the first RFID reader and writer 450 and the second RFID reader and writer 400 that is used (“NO” in the step S15), in a step S16, the controller 500 causes the display unit 520 to display, for example, a warning message saying “FAILED TO ACQUIRE DATA FROM RFID”, and terminates the image reading operation.

On the other hand, when the controller 500 has successfully read the data such as the ID data from the RFID tag 300G on the document G using either one of the first RFID reader and writer 450 and the second RFID reader and writer 400 (“YES” in the step S15), in a step S17, the controller 500 then writes the data selected in the above processing step S12 to the RFID tag 300G on the document G, using one of the first RFID reader and writer 450 or the second RFID reader and writer 400 that has successfully read the data in the previous steps. Once the data reading operation from the RFID tag 300G on the document G and the data writing operation to the RFID tag 300G on the document G is completed, in a step S18, the controller 500 uses the communication unit 530 to transmit the data read from the RFID tag 300G, the data written to the RFID tag 300G, and the image data read from the document G

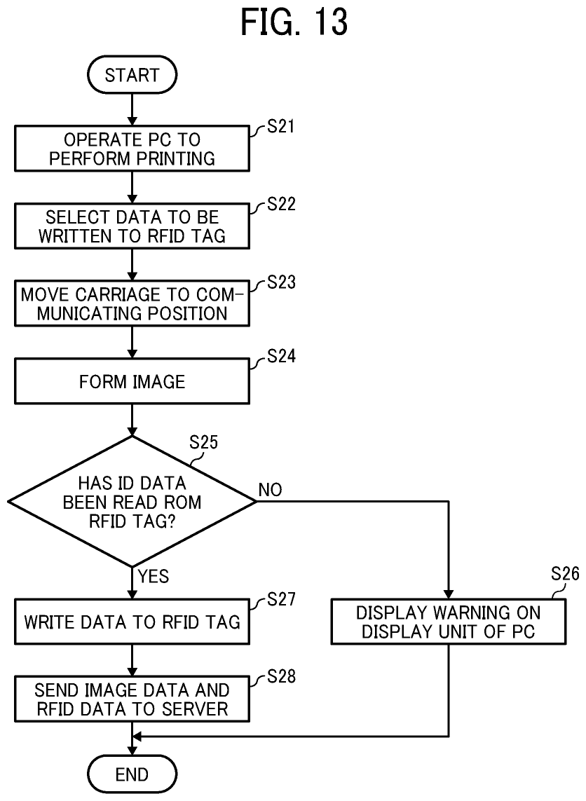

FIG. 13 is a flowchart of the operation of the image forming device 100 according to the above embodiments of the present disclosure.

When an image is to be formed on the sheet of paper P provided with the RFID tag 300P, in a step S21, first of all, for example, a personal computer (PC) is manipulated to make a selection, and such a selection includes selecting the image data whose image is to be printed and adjusting the image-forming condition. Moreover, when some data is to be written to the RFID tag 300P on the sheet of paper P, in a step S22, for example, a personal computer (PC) is manipulated to make a selection as to what data is to be written. The data to be written may be, for example, the date and time information, the user data, and the data of security level.

Once a result of the above selection is input from the PC through the communication unit 530, in a step S23, the controller 500 controls the carriage movement controller 240 to move the carriage 220 to the communicating position at which the short-range radio communication is performed with the RFID tag 300P on the sheet of paper P, and such a communicating position includes the position at which the carriage 220 is indicated by a solid line in FIG. 1 and the position at which the carriage 220 is indicated by a virtual line in FIG. 8. Subsequently, in a step S24, the elements of the image forming device 100 are controlled to perform the image-forming operation on the sheet of paper P.

In a step S25, the controller 500 then performs the data reading operation from the RFID tag 300P on the sheet of paper P while the sheet of paper P on which an image has been formed is being ejected to the upper output tray 50B, using the second RFID reader and writer 400 mounted on the carriage 220 and the third RFID reader and writer 460 of the upper output tray 50B. When the controller 500 has failed to read the data such as the ID data from the RFID tag 300P on the sheet of paper P regardless of the second RFID reader and writer 400 and the third RFID reader and writer 460 that is used (“NO” in the step S25), in a step S26, the controller 500 controls the communication unit 530 to send, for example, a warning message saying “FAILED TO ACQUIRE DATA FROM RFID” to a PC so as to be displayed on the display unit of the PC, and terminates the image-forming operation.

On the other hand, when the controller 500 has successfully read the data such as the ID data from the RFID tag 300P on the sheet of paper P using either one of the second RFID reader and writer 400 and the third RFID reader and writer 460 (“YES” in the step S25), in a step S27, the controller 500 then writes the data selected in the above processing step S22 to the RFID tag 300P on the sheet of paper P, using one of the second RFID reader and writer 400 or the third RFID reader and writer 460 that has successfully read the data in the previous steps. Then, once the data reading operation from the RFID tag 300P on the sheet of paper P and the data writing operation to the RFID tag 300P on the sheet of paper P is completed, in a step S28, the controller 500 uses the communication unit 530 to transmit the data read from the RFID tag 300P, the data written to the RFID tag 300P, and the image data formed on the sheet of paper P.

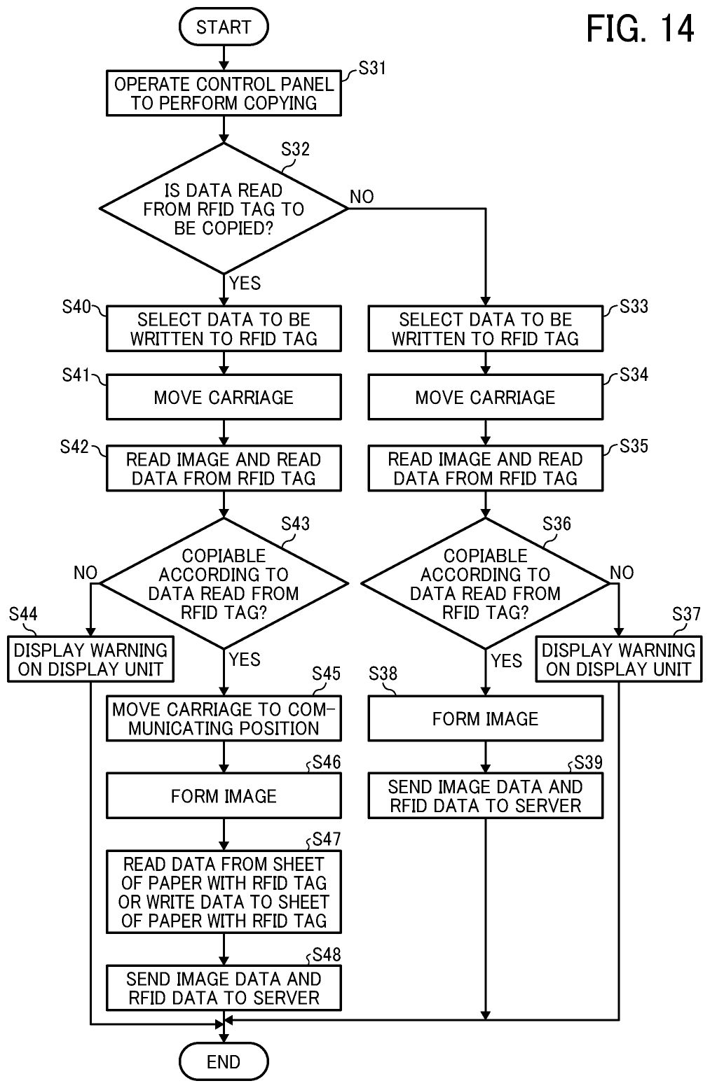

FIG. 14 is a flowchart of copying operation using the image reading unit 200 shaped like a flat plate, according to the first embodiment of the present disclosure.

When the image on the document G provided with the RFID tag 300G is to be scanned and copied, first of all, the document G is placed on the contact glass 210, and the document G is held by the pressure plate 251 as the cover 250 is closed.

Subsequently, in a step S31, a selection is made on the control panel 510 of the image forming apparatus 1 to set, for example, the conditions for image reading or scanning. In a step S32, a selection is made on the control panel 510 as to whether the data in the RFID tag 300G on the document G is to be copied together with the image on the document G.

When only the image on the document G is to be copied and the copying of the data in the RFID tag 300G on the document G is not selected (“NO” in the step S32) and some data is to be written to the RFID tag 300G on the document G, in a step S33, a selection is made as to what data is to be written. The data to be written may be, for example, the date and time information, the user data, and the data of security level. Then, in a step S34, the controller 500 moves the carriage 220. In a step S35, the controller 500 performs image reading operation to read the image on the document G placed on the contact glass 210 and performs data reading operation from the RFID tag 300G on the document G and data writing operation to the RFID tag 300G on the document G. When the controller 500 fails to read the data such as the ID data from the RFID tag 300G on the document G in the above step, the controller 500 causes the display unit 520 to display a warning message as described above.

Subsequently, in a step S36, the controller 500 determines whether the copying of the image on the document G is allowed or prohibited, based on the data such as the data of security level read from the RFID tag 300G on the document G. When it is determined that the copying is prohibited in the above step (“NO” in the step S36), in a step S37, for example, the controller 500 causes the display unit 520 to display a warning message saying “COPYING IS NOT ALLOWED FOR SECURITY REASONS”, and terminates the copying operation.

On the other hand, when it is determined that the copying is allowed in the above step (“YES” in the step S36), in a step S38, the controller 500 performs image-forming operation to cause the image forming device 100 to form the image read from the document G on the sheet of paper P. Subsequently, in a step S39, the controller 500 causes the communication unit 530 to transmit the data read from the RFID tag 300G, the data written to the RFID tag 300G, the image data read from the document G, and the image data formed on the sheet of paper P.

When the copying of the data in the RFID tag 300G on the document G is selected (“YES” in the step S32) and some data is to be written to the RFID tag 300G on the document G, in a step S40, a selection is made as to what data is to be written. The data to be written may be, for example, the date and time information, the user data, and the data of security level. Then, in a step S41, the controller 500 moves the carriage 220. In a step S42, the controller 500 performs image reading operation to read the image on the document G placed on the contact glass 210 and performs data reading operation from the RFID tag 300G on the document G and data writing operation to the RFID tag 300G on the document G. When the controller 500 fails to read the data such as the ID data from the RFID tag 300G on the document G in the above step, the controller 500 causes the display unit 520 to display a warning message as described above.

Subsequently, in a step S43, the controller 500 determines whether the copying of the image on the document G is allowed or prohibited, based on the data such as the data of security level read from the RFID tag 300G on the document G. When it is determined that the copying is prohibited in the above step (“NO” in the step S43), in a step S44, for example, the controller 500 causes the display unit 520 to display a warning message saying “COPYING IS NOT ALLOWED FOR SECURITY REASONS”, and terminates the copying operation.

On the other hand, when it is determined that the copying is allowed in the above step (“YES” in the S43), in a step S45, the controller 500 controls the carriage movement controller 240 to move the carriage 220 to the communicating position at which the short-range radio communication is performed with the RFID tag 300P on the sheet of paper P. The communicating position at which the short-range radio communication is performed with the RFID tag 300P on the sheet of paper P may be, for example, the position at which the carriage 220 is indicated by a solid line in FIG. 1 and the position at which the carriage 220 is indicated by a virtual line in FIG. 8. Subsequently, in a step S46, the controller 500 performs image-forming operation to cause the image forming device 100 to form the image read from the document G on the sheet of paper P.

Subsequently, when the sheet of paper P on which an image has been formed is ejected to the upper output tray 50B, in a step S47, the controller 500 according to the above embodiments of the present disclosure performs the data reading operation from the RFID tag 300P on the sheet of paper P and the data writing operation to the RFID tag 300P on the sheet of paper P, or performs the data writing operation of the data read from the RFID tag 300G on the document G. Subsequently, in a step S48, the controller 500 causes the communication unit 530 to transmit the data read from the RFID tag 300G or the RFID tag 300P, the data written to the RFID tag 300G or the RFID tag 300P, the image data read from the document G, and the image data formed on the sheet of paper P.

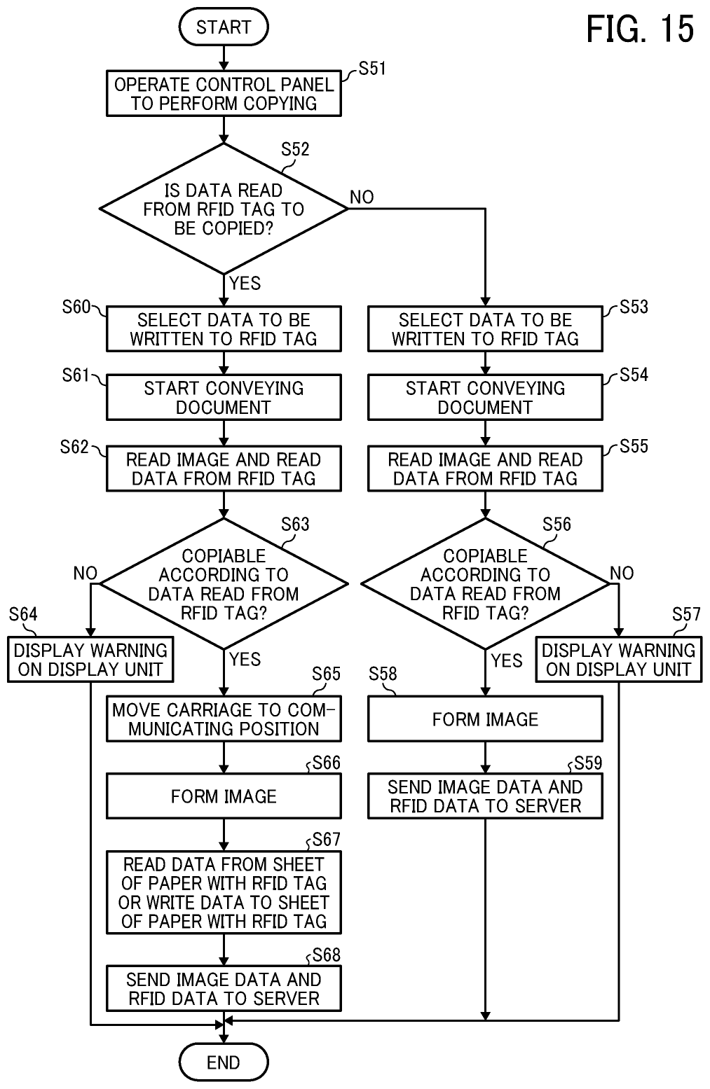

FIG. 15 is a flowchart of copying operation using the image reading unit 200 of sheet through type, according to the second embodiment of the present disclosure.

When the image on the document G provided with the RFID tag 300G is to be scanned and copied, first of all, the document G is set on the document table 610 as the ADF 600 is closed. Subsequently, in a step S51, a selection is made on the control panel 510 of the image forming apparatus 1 to set, for example, the conditions for image reading or scanning. In a step S52, a selection is made on the control panel 510 as to whether the data in the RFID tag 300G on the document G is to be copied together with the image on the document G.

When only the image on the document G is to be copied and the copying of the data in the RFID tag 300G on the document G is not selected (“NO” in the step S52) and some data is to be written to the RFID tag 300G on the document G, in a step S53, a selection is made as to what data is to be written. The data to be written may be, for example, the date and time information, the user data, and the data of security level. Then, in a step S54, the controller 500 causes the ADF 600 to convey the document G. In a step S55, the controller 500 performs image reading operation to read the image on the conveyed document G, and performs the data reading operation from the RFID tag 300G on the document G and the data writing operation to the RFID tag 300G on the document G. When the controller 500 fails to read the data such as the ID data from the RFID tag 300G on the document G in the above step, the controller 500 causes the display unit 520 to display a warning message as described above.

Subsequently, in a step S56, the controller 500 determines whether the copying of the image on the document G is allowed or prohibited, based on the data such as the data of security level read from the RFID tag 300G on the document G. When it is determined that the copying is prohibited in the above step (“NO” in the step S56), in a step S57, for example, the controller 500 causes the display unit 520 to display a warning message saying “COPYING IS NOT ALLOWED FOR SECURITY REASONS”, and terminates the copying operation.

On the other hand, when it is determined that the copying is allowed in the above step (“YES” in the step S56), in a step S58, the controller 500 performs image-forming operation to cause the image forming device 100 to form the image read from the document G on the sheet of paper P. Subsequently, in a step S59, the controller 500 causes the communication unit 530 to transmit the data read from the RFID tag 300G, the data written to the RFID tag 300G, the image data read from the document G, and the image data formed on the sheet of paper P.

When the copying of the data in the RFID tag 300G on the document G is selected (“YES” in the step S52) and some data is to be written to the RFID tag 300G on the document G, in a step S60, a selection is made as to what data is to be written. The data to be written may be, for example, the date and time information, the user data, and the data of security level. Then, in a step S61, the controller 500 causes the ADF 600 to convey the document G. In a step S62, the controller 500 performs image reading operation to read the image on the conveyed document G and performs data reading operation from the RFID tag 300G on the document G and data writing operation to the RFID tag 300G on the document G. When the controller 500 fails to read the data such as the ID data from the RFID tag 300G on the document G in the above step, the controller 500 causes the display unit 520 to display a warning message as described above.

Subsequently, in a step S63, the controller 500 determines whether the copying of the image on the document G is allowed or prohibited, based on the data such as the data of security level read from the RFID tag 300G on the document G. When it is determined that the copying is prohibited in the above step (“NO” in the step S63), in a step S64, for example, the controller 500 causes the display unit 520 to display a warning message saying “COPYING IS NOT ALLOWED FOR SECURITY REASONS”, and terminates the copying operation.

On the other hand, when it is determined that the copying is allowed in the above step (“YES” in the S63), in a step S65, the controller 500 controls the carriage movement controller 240 to move the carriage 220 to the communicating position at which the short-range radio communication is performed with the RFID tag 300P on the sheet of paper P, and such a communicating position includes the position at which the carriage 220 is indicated by a solid line in FIG. 1 and the position at which the carriage 220 is indicated by a virtual line in FIG. 8. Subsequently, in a step S66, the controller 500 performs image-forming operation to cause the image forming device 100 to form the image read from the document G on the sheet of paper P.

Subsequently, when the sheet of paper P on which an image has been formed is ejected to the upper output tray 50B, in a step S67, the controller 500 according to the above embodiments of the present disclosure performs the data reading operation from the RFID tag 300P on the sheet of paper P and the data writing operation to the RFID tag 300P on the sheet of paper P, or performs the data writing operation of the data read from the RFID tag 300G on the document G. Subsequently, in a step S68, the controller 500 causes the communication unit 530 to transmit the data read from the RFID tag 300G or the RFID tag 300P, the data written to the RFID tag 300G or the RFID tag 300P, the image data read from the document G, and the image data formed on the sheet of paper P.

For example, the document G or the sheet of paper P to which the RFID tag 300G or the RFID tag 300P is added may be utilized as follows.

### First Utilization Example

Conventionally, when paper documents such as the document G and the sheet of paper P are stored upon classification into a large number of cabinets in the office, it could take a very long time to search for a desired document or a target document from those cabinets. Typically, this is because documents need to be taken out on a one-by-one basis from each of the cabinets and the contents of each document needs to be checked. Even if the documents are appropriately classified into categories for each cabinet, there are some cases in which the documents that are shared by a lot of people are not returned to the original position, and it could take a very long time to search for a desired document or a target document.

If, for example, the document G or the sheet of paper P onto which the RFID tag 300G or the RFID tag 300P is pasted is used, such documents or sheets of paper can be managed. For example, the image on the document G is read by the image reading device, and the ID data of the RFID tag 300G on the document G is read and obtained. Then, those pairs of the obtained image data and ID data are associated with each other, and sent to the server. If the cabinet that stores such documents is provided with an RFID reader and writer, the ID data of the RFID is read and obtained from the RFID tag 300P of the document stored in the cabinet, and the obtained ID data is sent to the server. By so doing, the server can manage as to what document is stored in what cabinet. As a result, in what cabinet a desired document is stored can be observed through the server, and the length of time it takes to search for a desired document or a target document can significantly be shortened.

### Second Utilization Example

Conventionally, legal documents or the like have expiration dates for their storage, and any documents that have passed their expiration dates will be abandoned and thrown away. However, there are a large number of reported cases where the documents are abandoned and thrown away in error before passing the expiration dates for their storage. When legal documents or the like are abandoned and thrown away, a certain number of documents tends to be abandoned at once. One reason may be that documents that have not yet passed the expiration dates for their storage are blended into such a certain amount of document in an undesired manner and are abandoned and thrown away in error.

In order to handle such a situation, the RFID tag 300G or the RFID tag 300P is pasted onto a legal document, and for example, the image of such a legal document is read by the image reading device. Together with that, the ID data of the RFID tag 300G on that document is read and obtained, and the archival period is written to the RFID tag 300G. Due to such configurations as described above, when documents are abandoned and thrown away, the archival period of a large number of documents can be checked in a collective manner using, for example, an RFID reader of handy type, and whether any document that has not yet passed the expiration dates for their storage is blended into the above certain amount of document can be checked. Due to such configurations as described above, erroneous disposal can be prevented in simple and easy operation.

### Third Utilization Example

Conventionally, there are some cases in which a sheet of paper on which a driver's license or other sorts of license card is photocopied is requested to submit for the purpose of identification and is stored. In such cases, even if some sorts of tampering or manipulation are made, it is difficult to reveal. In order to handle such a situation, when the driver's license or other sorts of license card is photocopied, the data that is read from the RFID tag 300G on the driver's license or other sorts of license card may be written to the RFID tag 300P of the sheet of paper on which the image of the driver's license or other sorts of license card is photocopied. By so doing, double check is enabled using both the data written to the RFID tag 300P of that sheet of paper and the image of the driver's license or other sorts of license card photocopied on the sheet of paper, and tampering or manipulation can effectively be prevented.

### Fourth Utilization Example

Not only the ID data but also various kinds of information such as data containing several thousand words or more letters may be written to the RFID tag 300G or the RFID tag 300P and read from the RFID tag 300G or the RFID tag 300P. However, the data that is written to the RFID tag 300G or the RFID tag 300P cannot be recognized by human in a direct manner. The data that is stored in the RFID tag 300G or the RFID tag 300P may be read by an RFID reader, and the obtained data may be displayed on a screen. Due to such a method, the data that is written to the RFID tag 300G or the RFID tag 300P can be made recognizable by human. However, such a method has a disadvantage that the data cannot easily be seen or read on the screen when the amount of information is large. In order to handle such a situation, the data that is stored in the RFID tag can easily be recognized by human if the data stored in the RFID tag is read by the image reading unit 200 of the image forming apparatus 1 and the image of the read data is formed on the sheet of paper P by the image forming device 100.

The embodiments described above are given as an example, and unique advantageous effects are achieved for each of the following modes given below.

### First Mode

An image reading device according to the first mode of the present disclosure such as the image reading unit 200 includes a processing unit such as the controller 500 that performs short-range radio communication with an information storage unit such as the RFID tag 300G of an object to be scanned such as the document G to perform at least one of the data reading operation from an information storage unit provided for the object to be scanned and the data writing operation to the information storage unit. The image reading device according to the first mode of the present disclosure further includes a first antenna unit such as the first RFID reader and writer 450 configured to perform the short-range radio communication with the information storage unit provided for the object to be scanned using a first communication mode such as an RFID communication mode that uses a high-frequency (HF) radio or radar signal whose band of frequencies is high, and, and a second antenna unit such as the second RFID reader and writer 400 configured to perform the short-range radio communication with the information storage unit provided for the object to be scanned using a second communication mode such as an RFID communication mode that uses a ultrahigh frequency (UHF) radio or radar signal whose band of frequencies is ultrahigh. According to the present mode of the present disclosure, the processing unit is configured to perform the short-range radio communication to perform at least one of the data reading operation from the information storage unit and the data writing operation to the information storage unit, using the first communication mode or the second communication mode.

According to the first mode of the present disclosure, the short-range radio communication is performed with the information storage unit provided for the object to be scanned. As a result, at least one of the data reading operation from the information storage unit and the data writing operation to the information storage unit can be performed, using the first communication mode or the second communication mode. Due to such a configuration, even if various kinds of objects to be scanned are provided with two or more kinds of information storage units that use different types of communication modes, the data reading operation or the data writing operation can be performed with any one of the information storage units of the objects to be scanned, and various kinds of objects to be scanned can be dealt with.

### Second Aspect

According to the second mode of the present disclosure, the image reading device according to the first mode of the present disclosure further includes a pressing member such as the pressure plate 251 and the pressure plate 255 configured to hold an object to be scanned such as the document G placed on a mounting table such as a surface of the contact glass 210, and a moving scanner such as the carriage 220 configured to scan an image on the object to be scanned while moving along the mounting table. According to the present mode, the first antenna unit is disposed on the pressing member, and the second antenna unit is disposed on the moving scanner.

For example, the first antenna unit and the second antenna unit each of which uses a different type of communication mode may be mounted on the same member such as any desired one of the pressing member and the moving scanner. However, if the first antenna unit and the second antenna unit are mounted on the same member, the member on which a pair of antennas are mounted tends to increase in size, and upsizing of the image reading device is unavoidable.

According to the first mode of the present disclosure, the first antenna unit and the second antenna unit are disposed on the pressing member and the moving scanner, respectively, in a distributed manner. Due to such a configuration, the upsizing of each one of the pressing member and the moving scanner can be prevented, and the upsizing of the image reading device can easily be avoided.

### Third Mode

According to the third mode of the present disclosure, in the image reading device according to the second mode of the present disclosure, the first communication mode is a communication mode with a communication range shorter than a communication range of the second communication mode.

According to the present mode, the first antenna unit that is disposed on the pressing member, which is disposed closer to the object to be scanned than the moving scanner, adopts the short-range radio communication that is a communication mode with a short communication range, and the second antenna unit that is disposed on the moving scanner, which is disposed further from the object to be scanned than the pressing member, adopts the short-range radio communication that is a communication mode with a long communication range. Due to the present mode, the short-range radio communication with the information storage unit of the object to be scanned can appropriately be achieved using any one of the communication modes.

### Fourth Mode

According to the fourth mode of the present disclosure, in the image reading device according to the third mode of the present disclosure, the first communication mode and the second communication mode are communication modes that use radiofrequency identification and use radio or radar signals whose bands of frequencies are different from each other.

Due to such a configuration according to the fourth mode of the present disclosure, various kinds of objects to be scanned that are provided with a widespread RFID tag as an information storage unit can be dealt with.

### Fifth Mode

According to the fifth mode of the present disclosure, in the image reading device according to the fourth mode of the present disclosure, the first communication mode uses a radio or radar signal whose band of frequencies is high, and the second communication mode uses a radio or radar signal whose band of frequencies is ultrahigh.

Due to such a configuration according to the fifth mode of the present disclosure, both the widespread RFID tag that uses a HF radio or radar signal whose band of frequencies is high and the widespread RFID tag that uses a UHF radio or radar signal whose band of frequencies is ultrahigh can be dealt with.

### Sixth Mode

According to the sixth mode of the present disclosure, the image reading device according to any one of the second mode to the fifth mode of the present disclosure further includes a conveyance unit such as the ADF 600 configured to convey the object to be scanned, and the processing unit performs the short-range radio communication using the second antenna unit to perform at least one of the data reading operation from an information storage unit provided for the object to be scanned and the data writing operation to the information storage unit when the image on the object to be scanned that is being conveyed by the conveyance unit is to be scanned by the moving scanner that is kept in a stationary sate.

Due to such a configuration according to the sixth mode of the present disclosure, a large number of objects to be scanned can be dealt within a short period of time, and the productivity improves.

### Seventh Mode

According to the seventh mode of the present disclosure, the image reading device according to any one of the second mode to the fifth mode of the present disclosure further includes a conveyance unit such as the ADF 600 configured to convey the object to be scanned, a container such as the document ejection stage 620 that is arranged above the pressing member, where an object to be scanned that is conveyed by the conveyance unit is placed on the container. Moreover, according to the present mode, when the object to be scanned whose image is to be scanned and obtained while being conveyed by the conveyance unit is placed on the container, the processing unit performs the short-range radio communication using the first antenna unit to perform at least one of the data reading operation from an information storage unit provided for the object to be scanned and the data writing operation to the information storage unit.

Due to such a configuration according to the seventh mode of the present disclosure, even if the first antenna unit that is mounted on the pressing member adopts a communication mode in which the communication range is short, the data reading operation or the data writing operation can be performed with the information storage unit provided for the object to be scanned, which is conveyed to the container, through the short-range radio communication performed by the first antenna unit.

### Eighth Mode

According to the eighth mode of the present disclosure, in the image reading device according to the sixth mode or the seventh mode of the present disclosure, the conveyance unit is configured to convey the object to be scanned through a straight conveyance path in which the object to be scanned is conveyed without being bent.

Due to such a configuration according to the eighth mode of the present disclosure, even if the object to be scanned is, for example, a plastic card and a cardboard that cannot easily be bent and conveyed, the conveyance unit conveys the object to be scanned and the image on the object to be scanned is scanned, and the data reading operation from the information storage unit provided for the object to be scanned or the data writing operation to the information storage unit provided for the object to be scanned can be performed.

### Ninth Mode

According to the ninth mode of the present disclosure, an image forming apparatus 1 includes an image forming device 100 configured to form an image on a printing object such as the sheet of paper P, where a plurality of sheet ejection units such as the lower output tray 50A and the upper output tray 50B to which a printing object on which the image has been formed is ejected are provided on the upper side of the image forming device 100, and an image reading unit 200 disposed on an upper side of the image forming unit, where the image reading unit 200 is provided with a pressing member such as the pressure plate 251 and the pressure plate 255 configured to hold an object to be scanned such as the document G placed on a mounting table such as a surface of the contact glass 210 and a moving scanner such as the carriage 220 configured to scan an image on the object to be scanned while moving along the mounting table. According to the present mode, the image reading unit is equivalent to the image reading device according to any one of the first mode to the seventh mode of the present disclosure, and the image forming apparatus 1 according to the present mode further includes a data communication processing unit configured to perform short-range radio communication using at least one of the first antenna unit and the second antenna unit to perform at least one of data reading operation from an information storage unit such as the RFID tag 300P provided for a printing object that is ejected to the topmost one of the multiple sheet ejection units such as the upper output tray 50B and data writing operation to the information storage unit provided for the printing object that is ejected to the topmost one of the multiple sheet ejection units such as the upper output tray 50B.

According to the present mode, the data reading operation from the information storage unit of the printing object that is ejected to the multiple sheet ejection units of the image forming device or the data writing operation to the information storage unit of the printing object that is ejected to the multiple sheet ejection units of the image forming device can be performed using at least one of the first antenna unit and the second antenna unit of the image reading unit.

What is more, according to the present mode, the short-range radio communication is performed with the information storage unit of the printing object that is ejected to the topmost one of the multiple sheet ejection units closest to at least one of the first antenna unit and the second antenna unit among the multiple sheet ejection units of the image forming device. Due to such a configuration, the data communication can further be stabilized. In particular, if the communication range is appropriately set, the short-range radio communication can be performed only with the information storage unit of the printing object that is ejected to the topmost one of the multiple sheet ejection units among the multiple sheet ejection units of the image forming device, and a situation in which data is read from the information storage unit of the printing object that is ejected to the other sheet ejection units by mistake or data is written to the information storage unit of the printing object that is ejected to the other sheet ejection units by mistake can be avoided.

### Tenth Mode

According to the tenth mode of the present disclosure, an image forming apparatus 1 includes an image forming device 100 configured to form an image on a printing object such as the sheet of paper P, where a plurality of sheet ejection units such as the lower output tray 50A and the upper output tray 50B to which a printing object on which the image has been formed is ejected are provided on the upper side of the image forming device 100, and an image reading unit 200 disposed on an upper side of the image forming unit, where the image reading unit 200 is provided with a pressing member such as the pressure plate 251 and the pressure plate 255 configured to hold an object to be scanned such as the document G placed on a mounting table such as a surface of the contact glass 210 and a moving scanner such as the carriage 220 configured to scan an image on the object to be scanned while moving along the mounting table. According to the present mode, an antenna unit such as the second RFID reader and writer 400 configured to perform the short-range radio communication with the information storage unit such as the RFID tag 300P provided for the printing object is disposed on at least one of the pressing member and the moving scanner, and the image forming apparatus 1 according to the present mode further includes a data communication processing unit configured to perform short-range radio communication using the antenna unit to perform at least one of data reading operation from an information storage unit provided for a printing object that is ejected to the topmost one of the multiple sheet ejection units such as the upper output tray 50B and data writing operation to the information storage unit provided for the printing object that is ejected to the topmost one of the multiple sheet ejection units such as the upper output tray 50B.

According to the present mode, using at least one of the first antenna unit and the second antenna unit of the image reading unit that is ejected to the multiple sheet ejection units of the image forming device the data reading operation from the information storage unit of the printing object or the data writing operation to the information storage unit of the printing object can be performed.

What is more, according to the present mode, the short-range radio communication is performed with the information storage unit of the printing object that is ejected to the topmost one of the multiple sheet ejection units closest to at least one of the first antenna unit and the second antenna unit among the multiple sheet ejection units of the image forming device. Due to such a configuration, the data communication can further be stabilized. In particular, when the communication range is appropriately set, the short-range radio communication can be performed only with the information storage unit of the printing object that is ejected to the topmost one of the multiple sheet ejection units among the multiple sheet ejection units of the image forming device, and a situation in which data is read from the information storage unit of the printing object that is ejected to the other sheet ejection units by mistake or data is written to the information storage unit of the printing object that is ejected to the other sheet ejection units by mistake can be avoided.

### Eleventh Aspect

According to the eleventh mode of the present disclosure, in the image forming apparatus 1 according to the ninth mode or the tenth mode of the present disclosure, the antenna unit that the data communication processing unit uses is equivalent to the antenna unit disposed on the moving scanner.

Due to such a configuration according to the eleventh mode of the present disclosure, the moving scanner may be moved to move the antenna unit to a desired communicating position. Accordingly, the data reading operation from the information storage unit provided for the printing object or the data writing operation to the information storage unit provided for the printing object can appropriately be performed.

### Twelfth Mode

According to the twelfth mode of the present disclosure, in the image forming apparatus 1 according to any one of the ninth mode to the eleventh mode of the present disclosure, the topmost one of the plurality of sheet ejection units is disposed below the first antenna unit and the second antenna unit used by the data communication processing unit.

According to the present mode, the data reading operation from the information storage unit provided for the printing object or the data writing operation to the information storage unit provided for the printing object can appropriately be performed.

### Thirteenth Aspect

According to the thirteenth mode of the present disclosure, in the image forming apparatus 1 according to any one of the ninth mode to the twelfth mode of the present disclosure, the image forming device comprises a third antenna unit such as the third RFID reader and writer 460 configured to perform short-range radio communication with the information storage unit of the printing object that is ejected to the topmost one of the multiple sheet ejection units, using a communication mode different from the first communication mode or the second communication mode of the first antenna unit or the second antenna unit used by the data communication processing unit, and the data communication processing unit is configured to perform the short-range radio communication using the third antenna unit or the first antenna unit and the second antenna unit used by the data communication processing unit to perform at least one of data reading operation from the information storage unit disposed on the printing object that is ejected to the topmost one of the multiple sheet ejection units and data writing operation to the information storage unit disposed on the printing object that is ejected to the topmost one of the multiple sheet ejection units.

Due to such a configuration according to the thirteenth mode of the present disclosure, several kinds of communication mode can be used to perform communication with the information storage unit provided for the printing object that is ejected to the topmost one of the multiple sheet ejection units.

Note that numerous additional modifications and variations are possible in light of the above teachings. It is therefore to be understood that within the scope of the appended claims, the disclosure of the present disclosure may be practiced otherwise than as specifically described herein. For example, elements and/or features of different illustrative embodiments may be combined with each other and/or substituted for each other within the scope of this disclosure and appended claims.

What is claimed is:

1. An image reading device comprising:
a processing unit configured to perform short-range radio communication to perform at least one of data reading operation from an information storage unit mounted on an object to be scanned and data writing operation to the information storage unit;
a first antenna unit configured to perform the short-range radio communication with the information storage unit mounted on the object to be scanned using a first communication mode; and
a second antenna unit configured to perform the short-range radio communication with the information storage unit mounted on the object to be scanned using a second communication mode,
wherein the processing unit is configured to perform the short-range radio communication to perform at least one of the data reading operation from the information storage unit and the data writing operation to the information storage unit, using the first communication mode or the second communication mode.

2. The image reading device according to claim 1, further comprising:
a mounting table on which the object to be scanned is placed;
a pressing member configured to hold the object to be scanned placed on the mounting table; and
a moving scanner configured to scan an image on the object to be scanned while moving along the mounting table,
wherein the first antenna unit is disposed on the pressing member, and
wherein the second antenna unit is disposed on the moving scanner.

3. The image reading device according to claim 2,
wherein the first communication mode is a communication mode with a communication range shorter than a communication range of the second communication mode.

4. The image reading device according to claim 3,
wherein the first communication mode and the second communication mode are communication modes that use radiofrequency identification and use radio or radar signals whose bands of frequencies are different from each other.

5. The image reading device according to claim 4,
wherein the first communication mode uses a radio or radar signal whose band of frequencies is high, and
wherein the second communication mode uses a radio or radar signal whose band of frequencies is ultrahigh.

6. The image reading device according to claim 2, further comprising
a conveyance unit configured to convey the object to be scanned,
wherein, when an image on the object to be scanned that is being conveyed by the conveyance unit is scanned by the moving scanner that is kept in a stationary sate, the processing unit is configured to perform the short-range radio communication using the second antenna unit to perform at least one of the data reading operation from the information storage unit mounted on the object to be scanned and the data writing operation to the information storage unit.

7. The image reading device according to claim 2, further comprising:
a conveyance unit configured to convey the object to be scanned; and
a container disposed above the pressing member,
wherein the object to be scanned conveyed by the conveyance unit is placed on the container, and
wherein, when the object to be scanned whose image is to be scanned and obtained while being conveyed by the conveyance unit is placed on the container, the processing unit is configured to perform the short-range radio communication using the first antenna unit to perform at least one of the data reading operation from the information storage unit mounted on the object to be scanned and the data writing operation to the information storage unit.

8. The image reading device according to claim 6,
wherein the conveyance unit is configured to convey the object to be scanned through a straight conveyance path in which the object to be scanned is conveyed without being bent.

9. An image forming apparatus comprising:
an image forming device configured to form an image on a printing object, the image forming device having a plurality of sheet ejection units to which a printing object on which the image has been formed is ejected, the plurality of sheet ejection units being disposed on an upper side of the image forming device;
an image reading unit disposed on an upper side of the image forming device, the image reading unit including
a processing unit configured to perform short-range radio communication to perform at least one of data reading operation from an information storage unit mounted on an object to be scanned and data writing operation to the information storage unit,
a first antenna unit configured to perform the short-range radio communication with the information storage unit mounted on the object to be scanned using a first communication mode,
a second antenna unit configured to perform the short-range radio communication with the information storage unit mounted on the object to be scanned using a second communication mode,
a pressing member configured to hold an object to be scanned placed on a mounting table, and
a moving scanner configured to scan an image on the object to be scanned while moving along the mounting table; and
a data communication processing unit configured to perform the short-range radio communication using at least one of the first antenna unit and the second antenna unit to perform at least one of data reading operation from an information storage unit disposed on a printing object that is ejected to a topmost one of the plurality of sheet ejection units and data writing operation to the information storage unit,
wherein the processing unit is configured to perform the short-range radio communication to perform at least one of the data reading operation from the information storage unit and the data writing operation to the information storage unit, using the first communication mode or the second communication mode.

10. The image forming apparatus according to claim 9,
wherein the first antenna unit and the second antenna unit that the data communication processing unit uses are equivalent to the antenna unit disposed on the moving scanner.

11. The image forming apparatus according to claim 9,
wherein the topmost one of the plurality of sheet ejection units is disposed below the first antenna unit and the second antenna unit used by the data communication processing unit.

12. The image forming apparatus according to claim 9,
wherein the image forming device comprises a third antenna unit configured to perform short-range radio communication with the information storage unit of the printing object that is ejected to the topmost one of the plurality of sheet ejection units, using a communication mode different from the first communication mode or the second communication mode of the first antenna unit or the second antenna unit used by the data communication processing unit, and
wherein the data communication processing unit is configured to perform the short-range radio communication using the third antenna unit or the first antenna unit and the second antenna unit used by the data communication processing unit to perform at least one of data reading operation from the information storage unit disposed on the printing object that is ejected to the topmost one of the plurality of sheet ejection units and data writing operation to the information storage unit disposed on the printing object that is ejected to the topmost one of the plurality of sheet ejection units.

13. An image forming apparatus comprising:
an image forming device configured to form an image on a printing object, the image forming device having a plurality of sheet ejection units to which a printing object on which the image has been formed is ejected, the plurality of sheet ejection units being disposed on an upper side of the image forming device;
an image reading unit disposed on an upper side of the image forming device, the image reading unit including a pressing member configured to hold an object to be scanned placed on a mounting table and a moving scanner configured to scan an image on the object to be scanned while moving along the mounting table, at least one of the pressing member and the moving scanner including an antenna unit configured to perform short-range radio communication with an information storage unit mounted on the printing object; and
a data communication processing unit configured to perform short-range radio communication using the antenna unit to perform at least one of data reading operation from an information storage unit mounted on a printing object that is ejected to a topmost one of the plurality of sheet ejection units and data writing operation to the information storage unit.

14. The image forming apparatus according to claim 13,
wherein the first antenna unit and the second antenna unit that the data communication processing unit uses are equivalent to the antenna unit disposed on the moving scanner.

15. The image forming apparatus according to claim 13,
wherein the topmost one of the plurality of sheet ejection units is disposed below the first antenna unit and the second antenna unit used by the data communication processing unit.

16. The image forming apparatus according to claim 13,
wherein the image forming device comprises a third antenna unit configured to perform short-range radio communication with the information storage unit of the printing object that is ejected to the topmost one of the plurality of sheet ejection units, using a communication mode different from the first communication mode or the second communication mode of the first antenna unit or the second antenna unit used by the data communication processing unit, and
wherein the data communication processing unit is configured to perform the short-range radio communication using the third antenna unit or the first antenna unit and the second antenna unit used by the data communication processing unit to perform at least one of data reading operation from the information storage unit disposed on the printing object that is ejected to the topmost one of the plurality of sheet ejection units and data writing operation to the information storage unit disposed on the printing object that is ejected to the topmost one of the plurality of sheet ejection units.
